(19) United States
(12) Patent Application Publication
(10) Pub. No.: US 2020/0331710 A1
(43) Pub. Date: Oct. 22, 2020

(54) METHOD AND DEVICE FOR GROUPING INTO BATCHES BUOYANT OBJECTS WITH DYNAMIC HYDRAULIC SUPERPOSITION OF THE OBJECTS

(71) Applicant: MAF AGROBOTIC, Montauban (FR)

(72) Inventor: Stephane BLANC, MONTAUBAN (FR)

(21) Appl. No.: 16/956,954

(22) PCT Filed: Dec. 6, 2018
(86) PCT No.: PCT/FR2018/053132

§ 371 Date: Jun. 22, 2020

(30) Foreign Application Priority Data
Dec. 22, 2017 (FR) 17 63101

(51) Int. Cl. B65G 51/01; B65G 47/26

(52) U.S. Cl. CPC B65G 51/01; B65G 2203/044; B65G 2201/0211; B65G 47/265

(57) ABSTRACT

The invention relates to a method and a device for grouping into batches fragile buoyant objects, such as buoyant fruit, in at least one accumulation channel with hydraulic superposition of the objects held in a superposition zone against a closed holding/releasing device so as to hold the objects. During a step of accumulating objects in an accumulation channel (11), an elevation (17) extending upwards from the bottom (19) of the accumulation channel (11) is moved upstream in said superposition zone (18) from the downstream end (13) of the accumulation channel (11) as the objects are being supplied so as to cause a superposition of the objects held in the superposition zone between said elevation (17) and the holding/releasing device (14).

The invention relates to a method and a device for grouping into batches buoyant objects, in particular fragile objects such as buoyant fruit and vegetables (apples, tomatoes . . . ) or the like, with superposition of the objects in at least one hydraulic channel for accumulating the objects in batches.

Throughout the text, the expression “buoyant object” is intended to mean any object having sufficient buoyancy in a liquid stream to be able to be transported thereby. Consequently, this expression includes not only objects floating on the surface of the liquid stream but also in particular objects located just below the surface.

In installations for grading or sorting objects, such as fragile fruit, having channels for the hydraulic transportation of the objects (in particular ensuring that they are not damaged), it is of interest to be able to reduce the total length of each accumulation channel, allowing the objects to be grouped in batches, and thus the footprint of the entire installation.

Different devices to create a superposition of objects in such hydraulic channels have been proposed. EP2931635 and U.S. Pat. No. 9,694,366 describe a device for grouping, with superposition, named hydraulic superposition, of objects in accumulation channels, comprising a reduction in the cross-section formed by an elevation in the bottom of the accumulation channel producing a local acceleration of the speed of the hydraulic stream causing a superposition of the objects held in the superposition zone between this reduction in the cross-section and the holding/releasing device at the downstream end of the accumulation channel which is closed to hold the objects in the accumulation channel. This device thus makes it possible spontaneously to cause a hydraulic superposition, without inappropriate turbulence or damage to the objects, or, furthermore, overflow of the accumulation channel Such a superposition of the objects typically allows the length of each accumulation channel to be reduced by half.

However, the performance of such a device is limited and it is noted in practice that it is often difficult to obtain a superposition in more than two layers.

The invention thus aims to overcome these disadvantages. To this end, it aims to propose a method and a device for grouping into batches fragile buoyant objects allowing the formation of a more effective hydraulic superposition of objects in a superposition zone of each accumulation channel, i.e. in particular with a greater number of superposed layers.

More particularly, the invention aims to allow such an improved hydraulic superposition without inappropriate turbulence or damage to the objects, or, furthermore, overflow of the accumulation channel

The invention likewise aims in particular to allow such an improved hydraulic superposition without any yield losses of the installation, and even in contrast improving the production yield of the batches of objects.

The invention likewise aims to propose such a grouping method and such a grouping device which simultaneously have other advantages, in particular without requiring a reduced flow rate of the hydraulic stream.

Throughout the text, the terms “upstream” and “downstream” are used with reference to the direction of flow of the objects in the grouping device, likewise corresponding to the direction of flow of the hydraulic stream transporting these objects.

The invention thus relates to a method for grouping into batches buoyant objects—in particular fragile objects such as buoyant fruit or vegetables—in at least one channel, named accumulation channel, wherein:
a hydraulic stream able to transport the objects is formed in each accumulation channel,
an upstream portion of at least one accumulation channel is supplied with objects such that the objects are transported by the hydraulic stream along the accumulation channel to a downstream end thereof provided with a device for holding/releasing the objects, this holding/releasing device being transparent to the hydraulic stream flowing in the accumulation channel,
each accumulation channel having a bottom and side walls and, at least in a downstream portion thereof, named superposition zone, a height greater than twice the maximum vertical size of each object so as to be able to receive superposed objects,
the speed of the hydraulic stream formed in each accumulation channel is accelerated locally by an elevation extending upwards from the bottom of the accumulation channel forming a reduction in the cross-section of the accumulation channel having the effect of locally accelerating the speed of the hydraulic stream passing above this elevation, so as to cause a superposition of the objects held in the superposition zone of the accumulation channel between said elevation and the closed holding/releasing device to hold the objects,
   during a step of accumulating objects in an accumulation channel, said elevation is moved upstream in said superposition zone from the downstream end of the accumulation channel as the objects are being supplied.

The invention relates to a device allowing the implementation of a method in accordance with the invention. Therefore, the invention likewise relates to a device for grouping into batches buoyant objects—in particular fragile objects such as buoyant fruit or vegetables—comprising:
at least one channel, named accumulation channel,
a hydraulic supply device adapted to form, in each accumulation channel, a hydraulic stream able to transport the objects along the accumulation channel,
a device for supplying objects to an upstream portion of each accumulation channel,
each accumulation channel being provided, at a downstream end thereof, with a device for holding/releasing the objects contained therein, this holding/releasing device being transparent to the hydraulic stream flowing in the accumulation channel,
each accumulation channel having a bottom and side walls and, at least in a downstream portion thereof, named superposition zone, a height greater than twice the maximum vertical size of each object so as to be able to receive superposed objects,
each accumulation channel comprising an elevation extending upwards from the bottom of the accumulation channel adapted to form a reduction in the cross-section of the accumulation channel having the effect of locally accelerating the speed of the hydraulic stream passing above this elevation, so as to cause a superposition of the objects held in the superposition zone of the accumulation channel between said elevation and the closed holding/releasing device to hold the objects, :
said elevation of each accumulation channel is formed by a movable device in said superposition zone,
each accumulation channel has a motor-driven device for causing said movable device to move upstream in said superposition zone from the downstream end of the accumulation channel.

The invention likewise relates to a method implemented by a grouping device in accordance with the invention.

The inventor has noted with surprise that such a movement of an elevation locally forming a reduction in cross-section (or neck) in the superposition zone during the step of accumulation allows a gradual and homogeneous superposition of the objects to be obtained in the superposition zone, and a superposition of the objects in a greater number of layers to be obtained. In fact, it proves to be the case that the effect of superposition produced by this reduction in cross-section is much greater immediately downstream of this reduction in cross-section. Consequently, the movement of this reduction in cross-section upstream of the hydraulic stream allows the objects to be arranged in superposed layers gradually from the downstream end of the superposition zone upstream as the objects are being supplied in the superposition zone, with each object supplied in the superposition zone benefiting from the maximum superposition effect produced by this reduction in cross-section. A gradual superposition is thus achieved which can be referred to as “dynamic hydraulic superposition”.

Furthermore, this dynamic hydraulic superposition is obtained continuously, without the objects impacting against one another or against movable mechanical members, i.e. with risking damage to the objects themselves, even when the objects are extremely fragile.

It has been noted in practice with such a dynamic hydraulic superposition that the objects can be superposed in a number of layers greater than 2, typically of the order of 3 to 4 with buoyant fruit or vegetables such as apples, which allows the length of the accumulation channels to be further reduced by half with respect to a known hydraulic superposition device mentioned above.

It should be noted in this regard that the maximum number of superposition layers which can be obtained with buoyant objects is limited by the relative density of the objects with respect to the hydraulic stream. The invention allows superposition of the objects in a number of layers corresponding to this maximum number.

For example, if the accumulation channels of an earlier device without superposition of objects should have a length of the order of 12 m, the accumulation channels can have a length of the order of 6 m with a hydraulic superposition of the objects in accordance with EP2931635 and U.S. Pat. No. 9,694,366, and the accumulation channels can have a length of the order of 3 m with a dynamic hydraulic superposition in accordance with the present invention.

Therefore, in particular, in some embodiments of a grouping method and a grouping device in accordance with the invention the height of the accumulation channel in the superposition zone is selected based on the number of layers of superposed objects in the superposition zone and the maximum dimensions of each object. Therefore, the height of the accumulation channel in the superposition zone is greater than twice the maximum vertical size of each object. In the case of fruit or vegetables such as apples, the height of the accumulation channel in the superposition zone is advantageously between three and four times the maximum vertical size of each object. Other values are possible.

The hydraulic supply device is adapted to be able to form in each accumulation channel a hydraulic stream having, at least locally above said elevation, a speed able to cause a superposition of the objects held in the superposition zone of the accumulation channel downstream of the elevation against the closed holding/releasing device so as to hold the objects. The elevation and its movement in the superposition zone can be varied in a large number of ways.

In order to obtain a local acceleration of the speed of the hydraulic stream and a superposition of the objects immediately downstream of the elevation, it is sufficient in fact that the reduction in cross-section formed by the elevation locally reduces the passage cross-section of the hydraulic stream from the bottom and side walls of the accumulation channel.

The reduction in cross-section formed by said elevation locally reduces the passage depth of the hydraulic stream. In some embodiments, it is possible for provision to be made that this reduction in cross-section likewise locally reduces the passage width of the hydraulic stream. Nevertheless, this is generally not necessary such that in some preferred embodiments the reduction in cross-section formed by the elevation is only a reduction in vertical cross-section, the passage width of the hydraulic stream provided by the accumulation channel above the elevation not being reduced.

Said elevation partially forms a barrier to the flow of the hydraulic stream which accelerates as it passes above the elevation to flow downstream. Therefore, the elevation and said reduction in cross-section formed thereby always extend below the free surface of the hydraulic stream and at a distance from this free surface, providing—between this elevation and the free surface of the hydraulic stream—a passage cross-section of the hydraulic stream in which the speed of the hydraulic stream is locally accelerated.

In some preferred embodiments, the height of the elevation with respect to the bottom of the accumulation channel is less than or equal to the total depth of the hydraulic stream supplied into the accumulation channel, such that the latter is not raised substantially above the elevation, only its speed being locally increased.

In a method and a device in accordance with the invention, the elevation forms a reduction in cross-section only locally in the superposition zone, i.e. the length of the elevation (and thus of said reduction in cross-section, i.e. of the zone in which the speed of the hydraulic stream is accelerated) is as small as possible so as to limit the lost length of the superposition zone owing to the presence of the elevation. Therefore, the length of the elevation is less than the length of the superposition zone, notably less than half the length of the superposition zone, in particular less than a quarter the length of the superposition zone, more particularly less than a tenth the length of the superposition zone. For example, typically the length of the elevation (and thus of said reduction in cross-section, i.e. the zone in which the speed of the hydraulic stream is accelerated) is less than 1 m, in particular less than 50 cm, more particularly less than 30 cm, e.g. of the order of 10 cm to 25 cm.

In particular, in some possible embodiments of the invention, said elevation comprises an upstream face inclined upwards in the downstream direction.

Other embodiments are possible, notably with one (or more) portion(s) having a curved vertical longitudinal cross-section promoting, in the manner of a curved deflector, the local acceleration of the hydraulic stream and/or its orientation downwards downstream of the elevation and/or the turbulence downstream of the elevation, phenomena which can improve the immersion and superposition effect of the objects downstream of the elevation.

The movement of the elevation in the superposition zone along the accumulation channel can be achieved in various ways. For example, the elevation can be formed by at least one plate extending at least horizontally transversely in the hydraulic stream in the accumulation channel, this plate being guided in translation along the accumulation channel.

In some particularly advantageous embodiments in accordance with the invention, the elevation is formed by a carriage moved in the hydraulic stream in the superposition zone.

Therefore, a grouping method in accordance with these embodiments of the invention is also during a step of accumulating objects in an accumulation channel, a carriage, named accelerating carriage, forming said elevation is moved—in particular by a motor-driven drive device—upstream on the bottom of the accumulation channel in said superposition zone in the hydraulic stream from the downstream end of the accumulation channel as the objects are being supplied so as to cause the superposition of the objects in several layers in the superposition zone between said accelerating carriage and the closed holding/releasing device for holding the objects.

Similarly, a grouping device in accordance with these embodiments of the invention is also said elevation of each accumulation channel is formed by a carriage, named accelerating carriage, which can move along said superposition zone, and in that said motor-driven drive device is adapted to be able to cause said accelerating carriage to move upstream on the bottom of the accumulation channel in said superposition zone from the downstream end of the accumulation channel. Therefore, said at least one movable device is formed by an accelerating carriage which is adapted to be able to move in translation in and along the superposition zone. Advantageously and in accordance with the invention, said accelerating carriage is guided in translation in the superposition zone by at least one part of the walls (side walls and/or bottom) of the accumulation channel.

Furthermore, the elevation—in particular as formed by the accelerating carriage—preferably extends, within clearances allowing the movement of the accelerating carriage along the accumulation channel, over the entire width of the accumulation channel and from the bottom of the accumulation channel. As a variant, there is nothing to prevent the provision of at least one passage cross-section of the hydraulic stream between the bottom and the elevation and/or at least one passage cross-section of the hydraulic stream between the elevation and at least one side wall of the accumulation channel.

Therefore, according to one possible variant of the invention the accelerating carriage can be guided in translation in the accumulation channel only owing to the fact that it has a density close to that of the hydraulic stream such that it remains just below the surface in the hydraulic stream and is guided by the walls (side walls and/or bottom) of the accumulation channel in the superposition zone.

That being said, in some possible embodiments of the invention the carriage is guided in translation in the accumulation channel by a guiding device. Any guiding device can be envisaged to guide the elevation—notably the accelerating carriage—in translation along the accumulation channel in the superposition zone. For example, this guiding device can be selected from devices with members rolling along at least one wall forming the accumulation channel (side walls and/or bottom); devices with rail(s) and roller(s); devices with slide(s) in at least one runner; devices with glides sliding along at least one wall forming the accumulation channel (side walls and/or bottom); and combinations thereof. This elevation is guided in the hydraulic stream or above the hydraulic stream and/or on the side of the accumulation channel, and is driven by a motor-driven device such as a motor or actuator driving an endless screw or a winding drum of a cable or the like.

In particular, in some possible embodiments of the invention said accelerating carriage is provided with members rolling on the bottom of the accumulation channel. As a variant or in combination, the accelerating carriage can be provided with members rolling on at least one of the side walls of the accumulation channel. These rolling members can be selected notably from wheels, rolls, rollers.

Furthermore, in some advantageous embodiments of the invention said accelerating carriage is provided with members brushing at least one part of the walls of the accumulation channel. They can be in particular members brushing at least the bottom of the accumulation channel Preferably, the accelerating carriage is provided with members brushing the bottom and/or side walls of the accumulation channel over at least one part of their height. In this manner, the movement of the carriage in the accumulation channel likewise has the effect and advantage of cleaning the accumulation channel, thereby allowing specific cleaning phases to be obviated.

Furthermore, the elevation can be caused to move with respect to the accumulation channel by any suitable motor-driven drive device, notably being able to be selected from at least one motor on-board said accelerating carriage (the latter thus being of the self-propelled type, powered and/or controlled in its movements by a wireless connection or, in contrast, by a wired connection); at least one motor fixed to the frame of the accumulation channel and arranged to drive at least one driving member (cable(s), device with an endless screw and nut (ball screw) . . . ) connected to the elevation. Throughout the text, unless stated otherwise, the term “motor” and its derivatives mean any device allowing any non-mechanical energy to be converted into mechanical energy, and thus cover in particular rotating motors, such as electrical motors, and also actuators such as pneumatic and/or hydraulic cylinders or the like.

In some possible embodiments in accordance with the invention, said motor-driven drive device comprises:
at least one cable connected to said accelerating carriage, extending upstream of the accelerating carriage,
a motor-driven device pulling at least one such cable upstream.

For example, this motor-driven pulling device can comprise:
a drum for winding a cable, this drum being mounted to rotate about a rotational axis which is fixed with respect to a fame of the accumulation channel,
a motor coupled to the drum so as to be able to cause it to rotate in at least the winding direction of the cable on the drum.

The control of the movement of the elevation during each accumulation step can be varied in different ways.

According to a first possible variant, this movement is controlled at a fixed movement speed of the elevation upstream, this speed being able to be adjusted by the user so as to permit initial setting of the installation based upon the objects to be processed. Therefore, in this first variant the user makes an initial setting by adjusting the movement speed of the elevation—notably of the accelerating carriage—so as to optimise the superposition of the objects in the superposition zone.

According to a second possible variant, the movement of the elevation is controlled in a fully automatic manner upon control by a control unit such as a computer device programmed to this end.

In particular, in some embodiments of the invention during a step of accumulating objects in an accumulation channel:
said elevation is kept fixed in the accumulation channel until an amount of objects supplied in the accumulation channel is reached,
said elevation is moved upstream in the accumulation channel when said amount of objects supplied in the accumulation channel is reached.

It should be noted that this amount of objects supplied in the accumulation channel can be evaluated, detected or determined in different ways, and that it is not necessarily formed of a fixed value but in contrast can be varied based upon, for example, the time and/or position of the elevation in the superposition zone.

Thus, the control unit can be adapted to control the upstream movement of the elevation—notably the accelerating carriage:
based upon the amount of objects supplied in said upstream portion of the accumulation channel (this amount being able to be recorded or determined by the control unit, notably when the latter likewise controls the selective discharging of the objects in the accumulation channels);
based upon the objects present immediately upstream of the elevation and/or the superposed objects immediately downstream of the elevation, these objects being able to be detected by presence sensors and/or imaging devices (cameras) associated with image processing;
whether a sufficient superposition of objects is detected downstream of the elevation, preferably likewise whether the presence of objects is detected immediately upstream of the elevation.

In particular, according to one possible variant of the invention during a step of accumulating objects in an accumulation channel:
the presence of objects in an upstream zone of each accumulation channel is detected,
upon detection of the presence of objects in said upstream zone, said elevation—notably said accelerating carriage—is moved upstream,
if no objects are detected in said upstream zone, said elevation—notably said accelerating carriage—is held fixed in the accumulation channel

Therefore, a device in accordance with this variant of the invention comprises at least one sensor for the presence of objects in an upstream zone of each accumulation channel, each presence sensor being connected to a control unit adapted to control said motor-driven drive device so as to:
move said elevation—notably said accelerating carriage—upstream upon detection of the presence of objects in said upstream zone,
keep said reduction in cross-section—notably said accelerating carriage—fixed in the accumulation channel if no objects are detected in said upstream zone. More particularly, in some advantageous embodiments, said presence sensor is arranged in an upstream portion of said superposition zone, preferably in the upstream half, in particular ¾ upstream of said superposition zone.

Other variants are possible.

After said elevation is moved in the superposition zone during an accumulation step, the elevation is returned to the downstream end of the accumulation channel after emptying thereof, this return being able to be effected downstream either along the same path as that travelled upstream during the accumulation step but in the opposite direction, or along another path, for example by removing the elevation upwards out of the hydraulic stream.

That being said, in some preferred embodiments of the invention the downstream movement of the elevation—notably of said accelerating carriage—is performed by keeping the elevation in the hydraulic stream and in contact with the objects so as to urge the objects downstream. Therefore, during a step of emptying an accumulation channel the holding/releasing device is opened so as to allow the objects driven by the hydraulic stream to leave the accumulation channel, and said elevation—notably said accelerating carriage—is moved in said superposition zone to the downstream end of the accumulation channel, urging the objects out of the accumulation channel. Furthermore, advantageously during an emptying step said elevation—notably said accelerating carriage—is moved to the downstream end of the accumulation channel under the effect of the hydraulic stream—notably exclusively under the effect of the hydraulic stream.

Therefore, in a grouping device according to these embodiments of the invention said motor-driven drive device is adapted to allow movement of said movable device—notably said accelerating carriage—in said superposition zone to the downstream end of the accumulation channel During this downstream movement, said movable device—notably said accelerating carriage—urges the objects out of the accumulation channel, the holding/releasing device being open. Furthermore, advantageously the grouping device according to these embodiments of the invention is also each movable device—notably said accelerating carriage—is adapted to be able to be driven downstream under the effect—notably exclusively under the effect—of the hydraulic stream flowing in the accumulation channel, and in that said motor-driven drive device comprises a disengaging device able, in the disengaged position, to leave each movable device—notably said accelerating carriage—free to move downstream in the accumulation channel. As a variant, there is nothing to prevent provision being made that said motor-driven drive device is adapted to be able to cause each movable device—notably the accelerating carriage—to move downstream.

In a grouping method and a grouping device in accordance with the invention, the speed of supplying the hydraulic stream upstream of each accumulation channel is also adjusted to allow, taking into account the local acceleration generated by the elevation, an optimum superposition of the objects downstream of the elevation.

The adjustment of the speed of the hydraulic stream to cause this superposition of the objects can be varied in different ways. It is possible for example to maintain the speed of the hydraulic stream permanently at a constant and single value able to cause a superposition of the objects. It is also possible to count the objects (or total weight of the objects) introduced into each accumulation channel and to adjust the speed of the hydraulic stream to a value able to cause a superposition of the objects in an accumulation channel after having supplied this accumulation channel with a predetermined minimum number (or weight) of objects. It is likewise possible to detect (for example with photoelectric cells) the height taken up by the objects in the accumulation channel at one or more points along same and to adjust the speed of the hydraulic stream to a value able to cause a superposition of the objects when this height corresponds to a layer of objects. The adjustment of the different speeds of the hydraulic stream can be made discretely, i.e. by selecting a speed value from a plurality of predetermined values; or in contrast can be made continuously by continuously increasing the speed of the hydraulic stream until it reaches a value from which a superposition of the objects is detected in at least one predetermined zone of the accumulation channel.

For example, the speed of the hydraulic stream is adjusted to a first value whilst the number of objects introduced into an accumulation channel is less than or equal to a first number corresponding to a first layer of objects in this accumulation channel; then the speed of the hydraulic stream is adjusted to at least one second value causing a superposition of the objects in several layers downstream of the elevation when the number of objects introduced into the accumulation channel exceeds the first number.

Advantageously, in an advantageous variant of a method in accordance with the invention during an accumulation step:
the presence of objects in an upstream zone of each accumulation channel is detected,
if no objects are detected in this upstream zone, a first speed value is imparted to the hydraulic stream downstream of said upstream zone in the supply channel,
upon detection of the presence of objects in said upstream zone, a second speed value is imparted to the hydraulic stream downstream of said upstream zone in the suuply channel, this second value being greater than said first value and able to cause a superposition of the objects downstream of the elevation in the superposition zone of the accumulation channel, the holding/releasing device being closed so as to hold the objects.

Said first speed value is advantageously adapted to allow the superposition zone to be supplied with objects and objects to be accumulated in the superposition zone, avoiding any damage to the objects under the effect of impacts of the objects with the holding/releasing device and with each other. Therefore, in a method in accordance with the invention the speed of the hydraulic stream is initially adjusted to a first, relatively low, value sufficient to start supplying the hydraulic channel with objects minimising the impacts of the objects against each other during this initial supply which has the effect of forming a first layer of objects floating on the surface of the hydraulic stream in the accumulation channel However, this first speed value of the hydraulic stream is not necessarily sufficient itself to cause a hydraulic superposition of the products. When objects are detected in said upstream zone, i.e. when a first layer of objects is formed, this risk of impact no longer exists and it is thus possible to increase the speed of the hydraulic stream to a second value sufficient, during at least a certain time period, to thus cause a hydraulic superposition of the objects in the superposition zone. At the same time, the movement of the elevation upstream is controlled as the objects are being supplied.

Advantageously and in accordance with the invention, the speed of the hydraulic stream formed in each accumulation channel is adjusted by setting the flow rate of liquid delivered to an upstream inlet of the accumulation channel. This setting of flow rate can itself be effected using a simple butterfly valve, by adjusting the flow rate delivered by a pump upstream of each accumulation channel, or the like.

Furthermore, advantageously and in accordance with the invention the speed of the hydraulic stream is maintained at said second value and the elevation is moved upstream during a predetermined time period after detection of the presence of objects in said upstream zone. Advantageously and in accordance with the invention, this time period is determined to ensure that the superposition of the objects in the superposition zone has the effect of urging all the objects downstream past the elevation, preferably immediately downstream of the elevation which is moved upstream at the same time. In other words, said time period during which the speed of the hydraulic stream is adjusted to the second value causing the superposition of the objects is selected such that the upstream front of the objects accumulated in the superposition zone is located downstream—notably immediately downstream—of the elevation.

At the end of said predetermined time period, if the presence of objects in said upstream zone is no longer detected, the speed of the hydraulic stream is returned to said first value adapted for supplying the accumulation channel with objects under optimum conditions, and the elevation is kept stationary. The objects continuing to be supplied in the accumulation channel accumulate one against another upstream from this upstream front, above the elevation, until the presence of objects is once again detected in said upstream zone. The process is thus repeated by moving the elevation upstream and by adjusting the speed of the hydraulic stream to said second value to once again effect a superposition of objects which are urged towards the closed holding/releasing device.

Advantageously and in accordance with the invention, said first value of the speed as well as the reduction in cross-section formed by the elevation are also selected such that the objects are superposed, extending from downstream of the elevation to the closed holding/releasing device without tending to once again spread out into a lower degree of superposition.

The entire method in accordance with the invention can be implemented in an automatic manner using a control unit controlling the movement of the elevation—notably the accelerating carriage—an a valve actuator at the inlet of the hydraulic supply of each accumulation channel.

Each channel valve and/or said control unit can be adapted to allow adjustment of the channel valve in a single first position corresponding to a single first speed value or, in contract, in several positions which can be classified as first position, i.e. allowing adjustment of the speed of the hydraulic stream to a value which can be classified as first value (adapted to allow initial supplying of the superposition zone with objects and accumulation of objects in the superposition zone in a first layer) Similarly, each channel valve and/or said control unit can be adapted to allow adjustment of the channel valve in a single second position corresponding to a single second speed value or, in contrast, in several positions which can be classified as second position, i.e. causing a hydraulic superposition of the objects in the superposition zone.

Advantageously and in accordance with the invention, each channel valve is adapted to allow adjustment of the flow rate of the hydraulic stream in the accumulation channel based on said position of this channel valve. Each channel valve can equally be an optional rate valve, e.g. a butterfly valve, or an all-or-nothing valve (flap, relief valve . . . ).

The invention relates to a device comprising a single accumulation channel. However, it advantageously relates to a device which is also :
it comprises a plurality of accumulation channels,
said device for supplying objects is a selective supply device comprising at least one line, named grading line, for conveying, analysing and sorting objects based on predetermined criteria, said grading line comprising means for selectively discharging the objects into the different accumulation channels.

Furthermore, advantageously and in accordance with the invention the holding/releasing device of each accumulation channel is transparent with respect to the hydraulic stream flowing in the accumulation channel, including when this holding/releasing device is in the closed position for holding objects in the superposition zone.

In an advantageous embodiment, a device in accordance with the invention further comprises a hydraulic channel, named collecting channel, downstream of, and in communication with, each accumulation channel so as to be able to receive the hydraulic stream and objects discharged by the holding/releasing device in the open state, at least one station for receiving batches of objects delivered by said collecting channel, and a circuit (notably comprising at least one recirculation pump) for recirculating the hydraulic stream between each station for receiving batches of objects and said hydraulic supply device of each accumulation channel

A grouping device in accordance with the invention can be used for example as a unit for grading fruit or vegetables, for example apples or pears, the receiving station allowing each batch of objects from an accumulation channel to be packaged in a single package, for example an open crate and/or a box crate generally known as a “palox”, as described for example in FR 2868042 or U.S. Pat. No. 7,159,373. As a variation, the receiving station can be adapted to transfer each batch to a device for individual or grouped packaging of objects of the batch.

The invention allows a grouping device to be made particularly compact, and in this manner extremely simple and effective. It is most particularly advantageous in the case of a grouping device in accordance with the invention further the different accumulation channels are in parallel with each other and in that each grading line of the selective supply device is at least substantially orthogonal to each accumulation channel

The invention likewise relates to a grouping method and a grouping device which are characterised by all or some of the features mentioned in EP2931635 and U.S. Pat. No. 9,694,366.

The invention likewise relates to a grouping method and a grouping device which are characterised in combination or individually by all or some of the features mentioned above or below. However they are formally presented, unless explicitly stated otherwise, the different features mentioned above or below should not be considered to be closely or inextricably linked with each other, the invention being able to relate to only one of these structural or functional features, or only part of these structural or functional features, or even any group, combination or juxtaposition of all or some of these structural or functional features.

Other aims, features and advantages of the invention will become apparent upon reading the following description given by way of non-limiting example of some possible embodiments of the invention, and which makes reference to the attached figures in which:

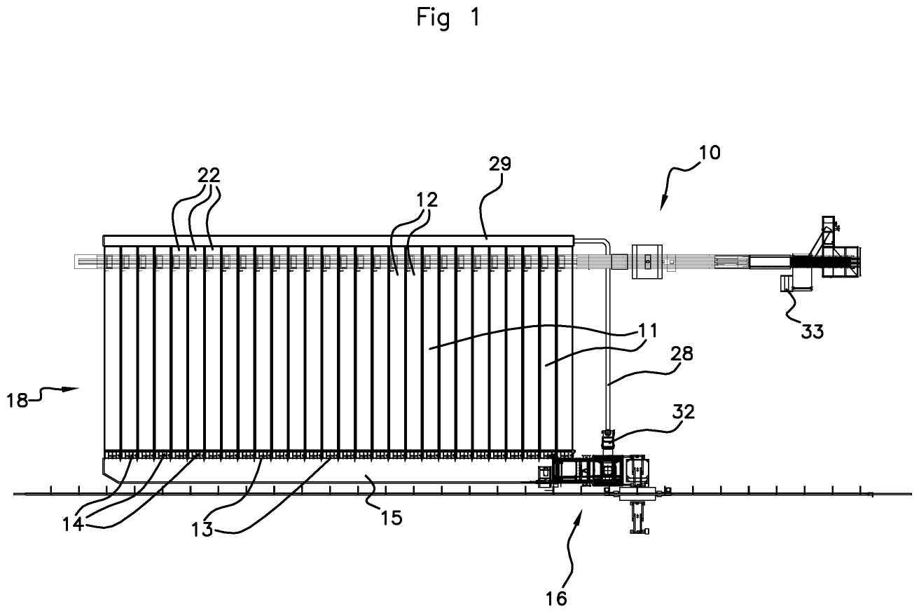

FIG. 1 is a top schematic view of a grouping device in accordance with the invention,

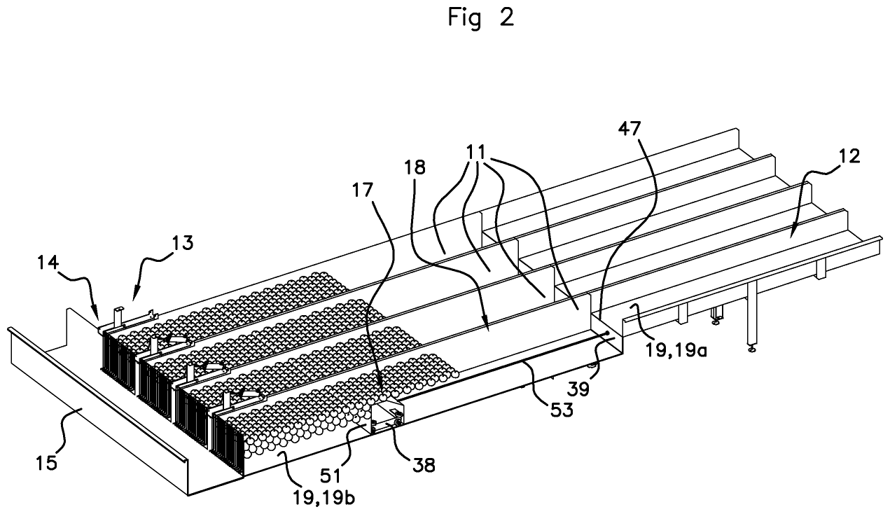

FIG. 2 is a partial perspective diagram, partially cut-away, of one possible embodiment of a grouping device in accordance with the invention,

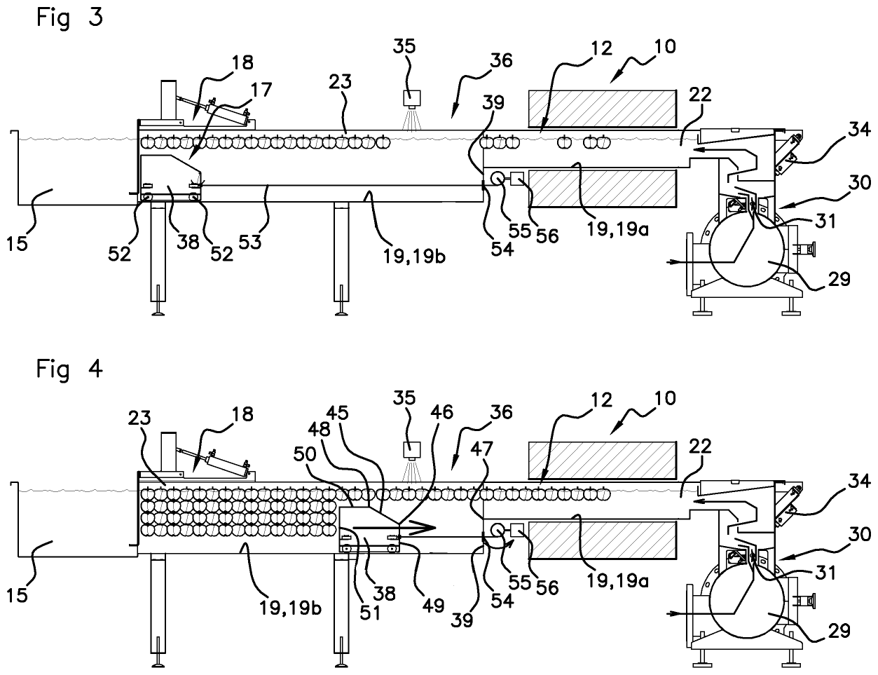

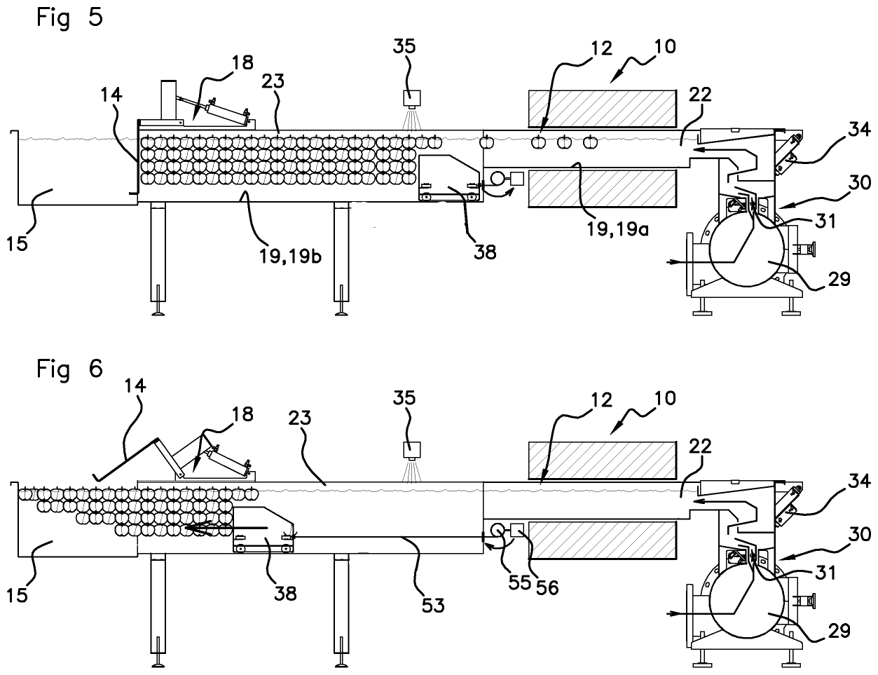

FIGS. 3 to 6 are longitudinal vertical sectional schematic views of an accumulation channel of a grouping device in accordance with the invention, showing different states of a grouping method in accordance with the invention,

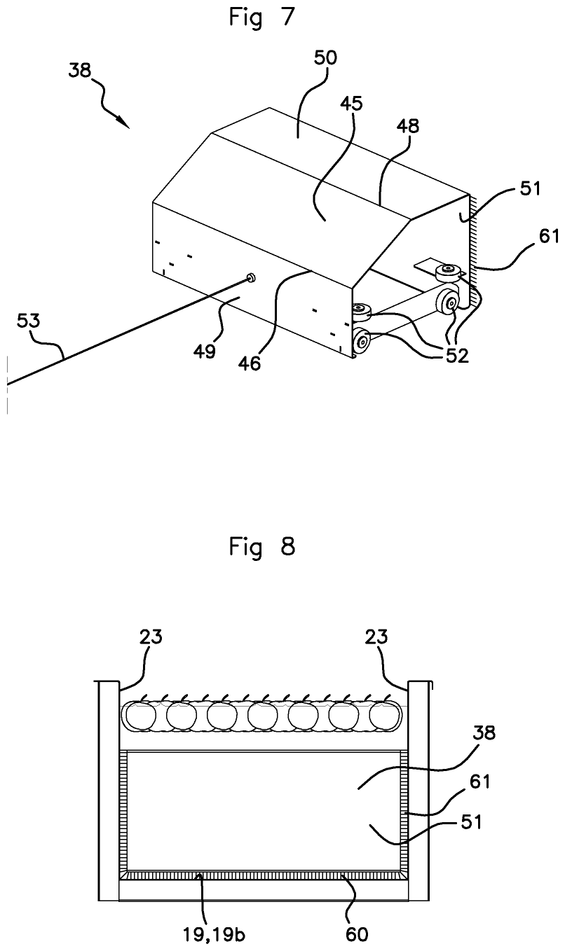

FIG. 7 is a perspective schematic view of an accelerating carriage of a grouping device in accordance with the invention,

FIG. 8 is a transverse vertical sectional view of an accumulation channel downstream of an accelerating carriage of a grouping device in accordance with the invention,

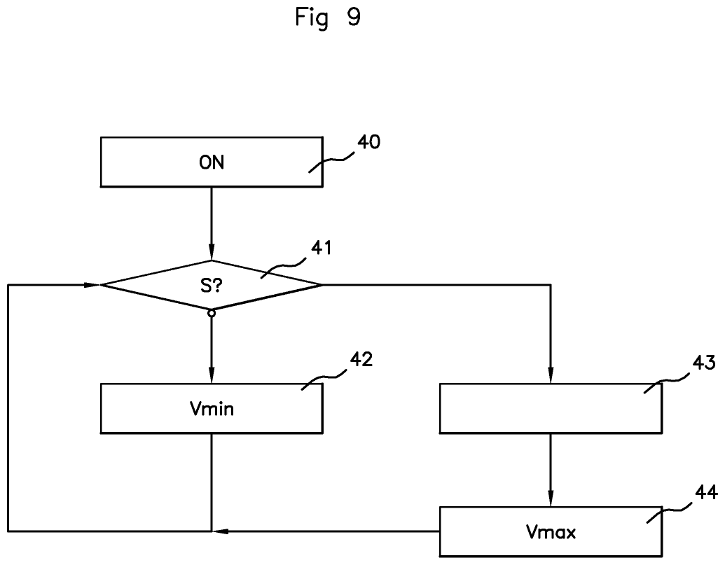

FIG. 9 is a schematic view of a logic diagram of an example of a method for controlling the upstream movements of an accelerating carriage in a grouping method in accordance with the invention.

The device in accordance with the invention shown in the figures comprises a line 10 for conveying, analysing and sorting objects based on predetermined criteria, this line 10, named grading line 10, being provided with means (not shown) for selectively discharging the objects into different accumulation channels 11 which extend on the whole orthogonally to the grading line 10, with an upstream end portion 12 located beneath the discharging means of the grading line 10. Such a grading line 10 is well known per se (cf. for example in particular EP 0729908, U.S. Pat. No. 7,159,373, U.S. Pat. No. 5,230,394, U.S. Pat. No. 5,280,838, U.S. Pat. No. 5,626,238, U.S. Pat. No. 6,234,297 . . . ). It generally has different object-analysing stations (weighing, optical analysis . . . ). Such a device can comprise any number—for example 5 to 50—of accumulation channels 11 in parallel with each other which adjoin one another laterally.

Preferably, each accumulation channel 11 is adapted to be able to receive a batch of buoyant objects intended to fill a single crate or palox at a receiving station 16 supplied by the collecting channel 15. However, this is not necessary and it is still possible that each batch of objects contained in an accumulation channel and released into the collecting channel 15 is subjected to other processing at the receiving station 16 or several receiving stations. Whatever the case may be, each accumulation channel 11 has a length sufficient to be able to receive all the objects of a single batch, to be subjected to the same subsequent processing. In practice, each accumulation channel 11 receives objects having specific features in terms of selection criteria, for example a predetermined size when the objects are fruit. In a single batch, all the objects thus have the same features, in particular the same size.

A hydraulic stream (generally water, possibly with processing additives) is supplied to, and passes along, the accumulation channels 11, said stream being generated by a hydraulic supply device provided with pumping and recirculation means, as described in terms of its general features for example by U.S. Pat. No. 7,159,373. The hydraulic stream formed in each accumulation channel 11 is adapted to be able to ensure the transportation of buoyant objects in the hydraulic stream, the latter having a free upper surface.

The hydraulic supply device comprises in particular a supply conduit 29 extending along all the upstream ends 22 of the accumulation channels 11 receiving the hydraulic flow generated by a recirculation pump 32 itself being connected to at least one receiving station 16 and to a conduit 28 for recirculating the hydraulic stream in a closed circuit.

The hydraulic supply device of each accumulation channel 11 comprises a controlled valve, named channel valve 30, at the upstream end 22 of each accumulation channel 11. This channel valve 30 is provided with a movable member 31 such as a butterfly allowing the regulation of the flow rate of the hydraulic stream supplying the accumulation channel 11. The position of the movable member 31 is controlled and the member is moved by an actuator such as a cylinder 34 itself connected to a control unit 33 of the installation as described hereinafter. In the example shown, the butterfly 31 of the channel valve 30 is mounted to rotate about a horizontal axis and the pivoting thereof is controlled by the cylinder 34 via a connecting rod.

The hydraulic stream flows in the accumulation channels 11 from their upstream portion 12 extending beneath the discharging means of the grading line 10 to their opposite downstream end 13 provided with a holding/releasing device 14 allowing, in a closed position, the objects to be held in the accumulation channel whilst allowing the hydraulic stream to pass therethrough, and allowing, in the open position, said objects to be released under the effect of the hydraulic stream to transfer them into a collecting channel 15 located downstream of all the accumulation channels 11. This holding/releasing device 14 can be formed by a simple movable grating, as described for example in WO 2012056186.

Each accumulation channel 11 is formed on the whole by a profile comprising a longitudinal horizontal bottom 19 and two vertical side walls 23.

The invention allows the creating, in each accumulation channel 11, of a superposition of the objects in several layers in the hydraulic stream of the accumulation channel 11, and to do so in a portion of the accumulation channel, named superposition zone 18, which is located downstream of said upstream portion 12 of the accumulation channel 11. This superposition zone 18 must have as long a length as possible with respect to the total length of the accumulation channel 11 between its upstream portion 12 and its downstream end 13.

In the illustrated example, the bottom 19 of the accumulation channel 11 is, in the superposition zone 18, on the whole horizontal and the vertical side walls 23 are of uniform height over the entire length of the superposition zone 18 of the accumulation channel 11. However, there is nothing to prevent provision being made that the accumulation channel 11 has a variable height, preferably increasing downstream, notably in the superposition zone 18, to facilitate the superposition of objects in this superposition zone 18.

Whatever the case may be, at least in the superposition zone 18, the total height of the accumulation channel 11 is greater than twice the maximum vertical size of each object so as to be able to receive superposed objects. Preferably, the total height of the accumulation channel 11 is greater than four times the maximum vertical size of each object, and is adapted to allow the vertical superposition of at least four objects one above the other in the hydraulic stream formed in the accumulation channel 11, preferably with clearance between the objects forming the lowermost layer in the hydraulic stream and the bottom 19 so as to void contact between the objects and the bottom 19 and to allow the hydraulic stream to flow freely in the accumulation channel 11.

More precisely, the total height of the accumulation channel 11 is, at least in the superposition zone 18, adapted to allow the superposition of objects one above the other in the hydraulic stream in the desired number of layers of objects in this superposition zone 18 and with a sufficient clearance kept between the objects and the bottom 19. Therefore, if at least four layers are intended to be formed, the depth of the hydraulic stream formed in the accumulation channel 11 must be sufficient to be able to receive these four layers in the hydraulic stream, with a clearance as mentioned above. It should be noted that in the superposition zone 18, the buoyant objects are not necessarily superposed strictly in uniform and homogeneous layers but in contrast more or less partially fit together, some of the objects being pushed down to be more fully immersed whilst others are possibly pushed up and are immersed to a lesser extent.

In the upstream portion 12 of each accumulation channel 11 located beneath the grading line 10, and immediately downstream thereof, the height of the accumulation channel 11 must be sufficient to be able to receive a layer of objects, with a sufficient clearance with the bottom 19 as indicated above. In fact, in this upstream portion 12 the objects are not superposed. Therefore, each accumulation channel 11 comprises said upstream portion 12 in which the bottom 19a of the accumulation channel 11 is, on the whole, horizontal at a first horizontal level, this upstream portion 12 being extended downstream by said superposition zone 18 in which the bottom 19b of the accumulation channel 11 is, on the whole, horizontal but at a second horizontal level lower than the first horizontal level, the bottom 19a of said upstream portion 12 being connected to the bottom 19b of the superposition zone 18 by a vertical wall 39 forming a downwards discontinuity in the downstream direction, this vertical wall 39 forming a transverse upstream wall of the superposition zone 18.

Preferably, the vertical side walls 23 have an upper edge 37 which is likewise, on the whole, horizontal over the entire length of the accumulation channel 11, i.e. along said upstream portion 12 and the superposition zone 18.

The superposition zone 18 of each accumulation channel 11 is provided with a carriage, named accelerating carriage 38, forming an elevation 17 with respect to the bottom 19 of the accumulation channel 11, this elevation 17 forming a reduction in cross-section having the effect of locally accelerating the speed of the hydraulic stream passing above the elevation 17 relative to the speed of the hydraulic stream at said upstream portion 12 supplying objects and relative to the speed of the hydraulic stream in the superposition zone 18 downstream of the elevation 17 and of the accelerating carriage 38. The elevation 17 extends, within clearances allowing the movement of the accelerating carriage 38 along the accumulation channel 11, over the entire width of the accumulation channel 11.

In the illustrated embodiment, the elevation 17 comprises, from upstream to downstream:
a face 45 inclined upwards having:
   a lower upstream edge 46 located at a lower level than the upper edge 47 of the upstream end transverse wall 39 of the superposition zone 18,
   and a downstream lower end 48 located:
      at a higher level than the upper edge 47 of the upstream end transverse wall 39 of the superposition zone 18,
      but below the free surface of the hydraulic stream flowing in the accumulation channel 11,
a horizontal face 50,
a vertical face 51.

The inclined face 45 and the horizontal face 50 allow the generation of the local acceleration of the speed of the hydraulic stream above the horizontal face 50. The vertical face 51 has the effect of suddenly directing the hydraulic stream downwards downstream of the horizontal face 50 and/or of generating turbulence which has the effect of promoting the immersion of the objects and the superposition thereof immediately downstream of the elevation 17. That being said, the shapes of the elevation 17 can be different, and in particular optimised to still further promote these phenomena. For example, the vertical face 51 can be replaced or supplemented with a curved deflector extending from the downstream edge of the horizontal face 50.

The elevation 17 forms a protuberance with respect to the level of the bottom 19b of the superposition zone 18 to locally accelerate the speed of the hydraulic stream in the superposition zone 18. Preferably, the elevation 17 likewise forms a protuberance with respect to the level of the bottom 19a of said upstream portion 12 so as to likewise locally accelerate the speed of the hydraulic stream when the accelerating carriage 38 is at the upstream end of the superposition zone 18 immediately downstream of the upstream portion 12. That being said, the elevation 17 is adapted to be located always beneath the free surface of the hydraulic stream as formed and supplied in the accumulation channel 11 at its upstream end 22, the hydraulic stream passing above the elevation 17 while accelerating but substantially without itself passing back over the elevation 17.

Preferably, the liquid flows from the supply conduit 29, which extends at a lower level than the accumulation channels 11, vertically upwards through each channel valve 30 to issue at the upstream end 22 of the accumulation channel 11 which, at this end, can have a bottom which is horizontal or is inclined downwards and downstream until forming said upstream portion 12 supplying objects by the grading line 10. The depth of the hydraulic stream in this upstream portion 12 is not necessarily the same as that in the superposition zone 18, and notably can be much lower, e.g. of the order of 200 mm.

Preferably, the entire device is adapted such that the free surface of the hydraulic stream remains at least substantially at the same horizontal level along the entire accumulation channel 11 (possibly with a slight downwards slope allowing the flow downstream to be promoted, this slight downwards slope corresponding to a slight inclination downwards and downstream of the bottom 19b of the accumulation channel 11 in the superposition zone 18). In this manner, the elevation 17 has the effect of promoting the superposition of the objects immediately downstream of this elevation 17, without in any way causing inappropriate impacts of the objects with each other.

The height of the elevation 17 is adapted such that the speed of the hydraulic stream locally above the elevation 17 and in an acceleration zone extending slightly upstream and downstream of this elevation 17 is higher than that of the hydraulic stream supplied upstream of the accumulation channel 11. The acceleration of the speed formed by the elevation 17 creates a superposition of the objects and maintains the superposed state of the objects. The height of the elevation 17 is in particular determined so as to optimise the superposition of the objects when the speed of the hydraulic stream supplied upstream of the accumulation channel 11 corresponds to a superposition speed Vmax. Such an elevation 17 has the effect of locally accelerating this superposition speed of the hydraulic stream by a large value, typically of the order of 50% or more.

Therefore, for example, whilst the depth of the hydraulic stream formed in the upstream portion 12 of the accumulation channel 11 is for example of the order of 100 mm to 150 mm, this same hydraulic stream has a depth of the order of 50 mm to 100 mm—notably of the order of 80 mm—in line with the elevation 17. The depth of the hydraulic stream in the superposition zone 18 is for example between 300 mm and 600 mm, for example of the order of 350 mm.

For example, if the depth of the hydraulic stream above the elevation 17 is of the order of 80 mm, then it is of the order of 350 mm in the superposition zone 18, when the accumulation speed of the hydraulic stream is of the order of 6 m/min in the superposition zone 18, the local speed is 30 m/min to 40 m/min above the elevation 17, i.e. an increase of more than 500%.

The accelerating carriage 38 forming the elevation 17 is provided with wheels 52 mounted to freely rotate on the accelerating carriage 38 about transverse horizontal axes allowing its movement on the bottom 19b of the superposition zone 18 between the grating of the holding/releasing device 14 and the upstream transverse vertical wall 39.

The accelerating carriage 38 likewise has an upstream vertical transverse wall 49 extending beneath the inclined face 45. A pulling cable 53 is fixed to the carriage 38, for example to its upstream wall 49. This pulling cable 53 extends horizontally upstream to the upstream end transverse vertical wall 39 of the superposition zone 18, which it passes via a sealed passage 54, to be wound on a drum 55 arranged beneath the passage 19a of the upstream portion 12 of the accumulation channel 11, outside the hydraulic stream. This sealed passage 54 can be obtained in that the cable 53 is formed by a plain wire passing a sized opening in the vertical wall 39, this opening possibly being provided with a seal. This drum 55 is connected to a drive motor 56 by a coupling allowing the drum 55 to be caused to rotate by the motor 56 at least in the winding direction of the pulling cable 53 around the drum 55. When the drive motor 56 is activated to drive the drum 55 in the winding direction of the pulling cable 53 around the drum 55, the accelerating carriage 38 is moved upstream in the superposition zone 18 as shown in FIG. 4.

Furthermore, the accelerating carriage 38 is advantageously provided with members 60, 61 for brushing the walls of the accumulation channel 11, for example in the form of at least one lower transverse brush 60 arranged to brush the bottom 19 of the superposition zone 18 and at least one pair of vertical side brushes 61 arranged to brush the side walls 23 of the superposition zone 18.

The drive motor 56 is advantageously provided with a disengaging unit. When this disengaging unit is activated, the drum 55 is free to rotate in the unwinding direction of the pulling cable 53. If the grating of the holding/releasing device 14 is raised (FIG. 6), the accelerating carriage 38 is thus driven downstream under the effect of the hydraulic stream, urging the objects into the collecting channel 15. The emptying of the accumulation channel 11 is thus greatly accelerated.

All of the grouping device in accordance with the invention is controlled by an (automated) control unit 33, generally formed by a computer system, adapted to control the different actuators and motors of the entire installation, notably the grading line 10, the discharging means, the holding/releasing devices 14 of the accumulation channels 11, the receiving station 16, the hydraulic supply device and in particular each channel valve 30 and its associated cylinder 34, the drive motors 56 of the accelerating carriages 38 . . . . This control unit 33 also receives different signals from different sensors or detectors of the device.

The control unit 33 can be programmed to move the accelerating carriage 38 in the superposition zone 18 in numerous different ways based upon the application requirements and the type of objects in question.

In some possible variants, the control unit 33 can be programmed to move the accelerating chariot 38 in a predetermined movement cycle, for example continuously at a predetermined constant speed or in predetermined successive jumps from the downstream end 13 of the superposition zone 18 to the upstream transverse vertical wall 39 of the superposition zone 18. Each predetermined cycle can be characterised by controls for the position and/or speed and/or acceleration of the accelerating carriage 38.

According to other possible variants which may be combined with the previous variants, the control unit 33 is programmed to control the movement of the accelerating carriage 38 based upon signals issued by at least one detection device such as at least one presence detection sensor and/or at least one camera . . . . In particular, the control unit can be adapted to control the movement of the accelerating carriage 38 in accordance with a closed-loop control allowing the optimisation of the superposition of the objects downstream of the accelerating carriage 38.

According to other possible variants which can be combined with the previous variants, the control unit 33 is programmed to control the movement of the accelerating carriage 38 based upon at least one parameter representing the amount of objects delivered in the accumulation channel 11 by the grading line 10, for example based upon the number of objects and/or volume of objects and/or weight of objects delivered in the accumulation channel 11, such parameters being able to be determined and compared with predetermined threshold values and/or those calculated in real time by the control unit 33 of the grading line 10.

In the illustrated embodiment, a photoelectric cell 35 is associated with each accumulation channel 11 so as to detect the presence of buoyant objects in an upstream portion 36 of the superposition zone 18. This photoelectric cell 35 is connected to the control unit 33 and adapted to be able to issue a signal corresponding to the detection of buoyant objects in front of the photoelectric cell 35, or corresponding to the fact that no such objects are detected. The photoelectric cell 35 is for example placed at a distance downstream of the transverse vertical wall 39 corresponding to the longitudinal dimension of the accelerating carriage 38, i.e. immediately downstream thereof when it is placed against the transverse vertical wall 39 of the superposition zone 18.

The control unit 33 controls on the one hand the cylinder 34 controlling the butterfly 31 of the channel valve 30, and on the other hand the drive motor 56 of the accelerating carriage 38 based on upon the detection signal issued by the photoelectric cell 35.

FIG. 9 shows an example of a control method which can be implemented by the unit 33 for controlling the movements of each accelerating carriage 38. After a step 40 of initiating the hydraulic circuit (starting the pump 32), the accelerating carriage 38 being placed at the downstream end 13 of the superposition zone 18 against the holding/releasing device 14 which is closed to hold the objects, the control unit 33 examines, during the testing step 41, whether the amount of objects supplied in the accumulation channel 11 is sufficient to be able to start the upstream movement of the accelerating carriage 38. As indicated above, this determination can be made in different ways. For example, the amount of objects supplied in the accumulation channel 11 can be determined by the control unit 33 based upon the amount of objects discharged by the grading line 10 and the upstream movement of the accelerating carriage 38 is triggered if this thus determined amount is greater than a predetermined threshold value (but which can subsequently vary based upon the position of the accelerating carriage 38 in the superposition zone 18).

According to a possible variant, the control unit 33 examines the state of the signal S issued by the photoelectric cell 35. If this signal S corresponds to no objects being detected (during a sufficient time period determined by timing) in the field of the photoelectric cell 35, the unit 33 controls (step 42) the cylinder 34 so as to keep the butterfly 31 of the channel valve 30 in the position of minimum flow rate, corresponding to a first average speed value of the hydraulic stream and in particular at a first, relatively low, accumulation speed value Vmin of the hydraulic stream supplying the accumulation channel 11. This first speed value is adjusted to allow the accumulation of objects delivered by the grading line 10 against the holding/releasing device 14 in the closed state at the downstream end 13 of the supply channel 11 and to minimise the impacts between the holding/releasing device 14 and the objects and between the objects themselves (FIG. 3). For example, the flow rate delivered by the channel valve 30 in the position of minimum flow rate of the butterfly 31 corresponds to an average accumulation speed of the hydraulic stream of the order of 5 to 10 m/min.

When the signal S issued by the photoelectric cell 35 corresponds to the presence of objects in the field of the photoelectric cell 35, the unit 33 controls (step 43) the motor 56 in the winding direction of the drum 55 so as to cause the movement of the accelerating carriage 38 upstream over a predetermined distance, e.g. corresponding to a longitudinal dimension of the accelerating carriage 38. Furthermore, the unit 33 controls (step 44) the cylinder 34 so as to place and keep the butterfly 31 of the channel valve 30 in the position of maximum flow rate, corresponding to a second average speed value of the hydraulic stream, and in particular to a second superposition speed value Vmax, higher than said first accumulation speed value Vmin, of the hydraulic stream passing above the elevation 17 of the accumulation channel 11. This second speed value is adjusted to cause the superposition of buoyant objects in the hydraulic stream one above the other downstream of the elevation 17, these objects being urged downstream by the hydraulic stream under the effect of this speed (FIG. 4) and the acceleration generated locally by the elevation 17. For example, the flow rate delivered by the channel valve 30 in the position of maximum flow rate of the butterfly 31 corresponds to an average superposition speed of the hydraulic stream of the order of 10 to 25 m/min.

The control unit 33 keeps the accelerating carriage 38 in position and maintains this second superposition speed value during a predetermined time period, and then repeats the testing step 41. This time period is determined so as to obtain a sufficient superposition of the objects downstream of the elevation 17 between the holding/releasing device 14 and the elevation 17.

As a variant which is not illustrated, there is nothing to prevent the provision of at least one camera allowing the detection of the superposition of the objects downstream of the elevation 17 in a sufficient number of layers, the control unit 33 being adapted to analyse the images produced by such a camera and count the number of superposition layers of the objects in the superposition zone 18. A plurality of such cameras can be distributed along the superposition zone 18, for example along the side walls provided to this end with viewing windows.

The above-mentioned steps 41 to 44 can be repeated until the number of objects forming a batch of objects in the superposition zone 18 is achieved. The length of the superposition zone 18 is adapted such that this number of objects forming a batch can be fully contained in the superposition zone 18 between the accelerating carriage 38 and the holding/releasing device 14. Therefore, to this end, when the accelerating carriage 38 is in the upstream end position against the upstream transverse vertical wall 39 of the superposition zone 18, the available length to contain the superposed objects between the accelerating carriage 38 and the holding/releasing device 14 is preferably greater than that strictly necessary to contain the greatest number of objects forming a batch of superposed objects in the superposition zone 18. In this manner, the accelerating carriage 38 is prevented from coming into abutment with this upstream transverse wall 39.

The number of objects delivered into the accumulation channel 11 is counted for example at the level of the discharging means of the grading line 10, the latter being adapted to discharge the objects individually. It should be noted that the filling time for each accumulation channel 11 can vary greatly in practice, notably by less than one minute for most objects to several days for a minority of objects. When the number of superposed objects in the superposition zone 18 corresponding to a batch is achieved, the holding/releasing device 14 can be opened, and only if the receiving station 16 is ready to receive and process the batch from this accumulation channel 11. Simultaneously, the control unit 33 triggers the disengagement of the motor 56, the drum 55 being able to be unwound freely, the accelerating carriage 38 thus being able to be moved downstream in the superposition zone 18 under the effect of the hydraulic stream. The superposed objects are thus driven by the hydraulic stream and urged by the accelerating carriage 38 downstream in the collecting channel 15.

By using a method and a device in accordance with the invention, owing to the gradual superposition of the objects in the superposition zone of each accumulation channel 11 in a large number of layers, the total length of each accumulation channel 11 can be greatly reduced, which has the advantage of making the entire installation much more compact. Furthermore, the superposition occurs much more quickly. Likewise, the guiding of the accumulation channel 11 is greatly accelerated. The result is a marked improvement in the productivity of the installation.

It goes without saying that the invention can be varied in numerous ways compared with the embodiment shown in the figures and described above. In particular, several photoelectric cells and/or several cameras can be provided, allowing the control of the presence of the objects and effective superposition thereof for each accumulation channel 11. The accelerating carriage 38 can be a self-propelled carriage and/or carry at least one photoelectric cell and/or at least one camera connected to the control unit 33, in particular by a wireless connection.

Furthermore, several different positions of the butterfly 31 can be provided, corresponding to several different speed values, in the accumulation phase as well as in the superposition phase. For example, the superposition speed Vmax can be initially relatively low (initially, it must be just sufficient to start to create a superposition of the objects) and increased during the different successive superposition phases to reach a maximum value at the end of accumulation of a batch of objects, the superposition of the objects thus requiring more energy. For example, it is possible to increase the value of the superposition speed based upon the number of layers of superposed objects in the superposition zone 18.

It is also possible to vary the position of the butterfly 31 continuously (and not in discrete steps), and thus to continuously vary the flow rate of the hydraulic stream and the speed thereof. In particular, it is possible for provision to be made that the unit 33 controls a continuous variation of the position of the butterfly 31 from the accumulation speed until a sufficient value is reached corresponding to a superposition speed, i.e. able to cause a hydraulic superposition of the objects, the superposition being detected by at least one photoelectric cell and/or at least one camera.

Furthermore, the grading line 10 can be replaced by any other selective supply device for the accumulation channels. And the collecting channel 15 and the receiving station 16 can be replaced by any other device for processing batches of objects discharged downstream of the accumulation channels 11.

Likewise, there is nothing to prevent provision being made, as a variant, that the drive motor 56 is adapted to cause the drum 55 to rotate in the unwinding direction of the pulling cable 53. Likewise, there is nothing to prevent, as another variant, the provision of a drive cable arranged to form a loop having two ends, one connected upstream of the accelerating carriage, the other connected downstream of the carriage, this loop being driven by a suitable motor-driven device, either upstream or downstream. Likewise, instead of passing through the vertical wall 39 the drive cable of the accelerating carriage can be returned upwards above the accumulation channel, the drum and the drive motor of this drum being placed above the accumulation channel. The risks of leakage when passing through the wall are thus avoided.

The invention can cover numerous variants and applications other than those described above. In particular, it goes without saying that, unless stated otherwise, the different structural and functional features of each of the embodiments described above do not have to be considered as being combined and/or closely and/or inextricably linked with each other, but in contrast considered as simple juxtapositions. Furthermore, the structural and/or functional features of the different embodiments described above can form, in their entirety or in part, any different juxtaposition or any different combination.

1. Method for grouping into batches buoyant objects in at least one channel, named accumulation channel, wherein:
a hydraulic stream able to transport the objects is formed in each accumulation channel,
an upstream portion of at least one accumulation channel is supplied with objects such that the objects are transported by the hydraulic stream along the accumulation channel to a downstream end thereof provided with a device for holding/releasing the objects, this holding/releasing device being transparent to the hydraulic stream flowing in the accumulation channel,
each accumulation channel having a bottom and side walls and, at least in a downstream portion thereof, named superposition zone, a height greater than twice the maximum vertical size of each object so as to be able to receive superposed objects,
the speed of the hydraulic stream formed in each accumulation channel is accelerated locally by an elevation extending upwards from the bottom of the accumulation channel forming a reduction in the cross-section of the accumulation channel having the effect of locally accelerating the speed of the hydraulic stream passing above this elevation, so as to cause a superposition of the objects held in the superposition zone of the accumulation channel between said elevation and the closed holding/releasing device to hold the objects,
wherein during a step of accumulating objects in an accumulation channel, said elevation is moved upstream in said superposition zone from the downstream end of the accumulation channel as the objects are being supplied.

2. Method according to claim 1, wherein during a step of accumulating objects in an accumulation channel, a carriage, named accelerating carriage, forming said elevation is moved upstream on the bottom of the accumulation channel in said superposition zone in the hydraulic stream from the downstream end of the accumulation channel as the objects are being supplied so as to cause the superposition of the objects in several layers in the superposition zone between said accelerating carriage and the closed holding/releasing device for holding the objects.

3. Method according to claim 1, wherein during a step of emptying an accumulation channel the holding/releasing device is opened so as to allow the objects driven by the hydraulic stream to leave the accumulation channel, and said elevation is moved in said superposition zone to the downstream end of the accumulation channel, urging the objects out of the accumulation channel.

4. Method according to claim 3, wherein during an emptying step said elevation is moved to the downstream end of the accumulation channel under the effect of the hydraulic stream.

5. Method according to claim 1, wherein during a step of accumulating objects in an accumulation channel:
said elevation is kept fixed in the accumulation channel until an amount of objects supplied in the accumulation channel is reached,
said elevation is moved upstream in the accumulation channel when said amount of objects supplied in the accumulation channel is reached.

6. Device for grouping into batches buoyant objects, comprising:
at least one channel, named accumulation channel,
a hydraulic supply device adapted to form, in each accumulation channel, a hydraulic stream able to transport the objects along the accumulation channel,
a device for supplying objects to an upstream portion of each accumulation channel,
each accumulation channel being provided, at a downstream end thereof, with a device for holding/releasing the objects contained therein, this holding/releasing device being transparent to the hydraulic stream flowing in the accumulation channel,
each accumulation channel having a bottom and side walls and, at least in a downstream portion thereof, named superposition zone, a height greater than twice the maximum vertical size of each object so as to be able to receive superposed objects,
each accumulation channel comprising an elevation extending upwards from the bottom of the accumulation channel adapted to form a reduction in the cross-section of the accumulation channel having the effect of locally accelerating the speed of the hydraulic stream passing above this elevation, so as to cause a superposition of the objects held in the superposition zone of the accumulation channel between said elevation and the closed holding/releasing device to hold the objects,
wherein:
said elevation of each accumulation channel is formed by a movable device in said superposition zone,
each accumulation channel has a motor-driven device for causing said movable device to move upstream in said superposition zone from the downstream end of the accumulation channel.

7. Device according to claim 6, said elevation comprises an upstream face inclined upwards and downstream.

8. Device according to claim 6, wherein said elevation of each accumulation channel is formed by a carriage, named accelerating carriage, which can move along said superposition zone, and in that said motor-driven drive device is adapted to be able to cause said accelerating carriage to move upstream on the bottom of the accumulation channel in said superposition zone from the downstream end of the accumulation channel.

9. Device according to claim 8, wherein said accelerating carriage is guided in translation in the superposition zone by at least one part of the walls of the accumulation channel.

10. Device according to claim 8, wherein said accelerating carriage is provided with members brushing at least one part of the walls of the accumulation channel

11. Device according to claim 8, wherein said motor-driven drive device comprises:
at least one cable connected to said accelerating carriage, extending upstream of the accelerating carriage,
a motor-driven device pulling at least one such cable upstream.

12. Device according to claim 6, wherein said motor-driven drive device is adapted to allow movement of said movable device in said superposition zone to the downstream end of the accumulation channel.

13. Device according to claim 7, wherein each movable device is adapted to be able to be driven downstream under the effect of the hydraulic stream flowing in the accumulation channel.

14. Device according to claim 6, wherein:
it comprises a plurality of accumulation channels,
said device for supplying objects is a selective supply device comprising at least one line, named grading line, for conveying, analysing and sorting objects based on predetermined criteria, said grading line comprising means for selectively discharging the objects into the different accumulation channels.

15. Device according to claim 14, wherein the different accumulation channels are in parallel with each other, and in that each grading line of the selective supply device is at least substantially orthogonal to each accumulation channel.

16. Device according to claim 6, wherein said device further comprises a hydraulic channel, named collecting channel, downstream of, and in communication with, each accumulation channel so as to be able to receive the hydraulic stream and objects discharged by the holding/releasing device when the latter is open, at least one station for receiving batches of objects delivered by said collecting channel, and a circuit for recirculating the hydraulic stream between each station for receiving batches of objects and said hydraulic supply device of each accumulation channel.

17. Device according to claim 6, wherein said hydraulic supply device comprises, upstream of each accumulation channel, a controlled valve, named channel valve, arranged to be able to be placed in at least one first position corresponding to a first average speed value of the hydraulic stream in said accumulation channel and in at least one second position corresponding to at least one second average speed value, higher than each first value, of the hydraulic stream able to cause a superposition of the objects in the superposition zone of the accumulation channel against the closed holding/releasing device so as to hold the objects,
it comprises a control unit adapted to control each channel valve between said positions.
